(19) United States
(12) Patent Application Publication
(10) Pub. No.: US 2025/0251529 A1
(43) Pub. Date: Aug. 7, 2025

(54) SYSTEM AND METHOD FOR GENERATING A MICROBIAL GAS FAVORABILITY INDEX MAP

(71) Applicant: CHEVRON U.S.A. INC., San Ramon, CA (US)

(72) Inventors: Jianchang LIU, Katy, TX (US); Fang LIN, Sugar Land, TX (US); Michael HSIEH, Sugar Land, TX (US); Barry Jay KATZ, Houston, TX (US); Yushi ZHAO, Missouri City, TX (US)

(73) Assignee: CHEVRON U.S.A. INC., San Ramon, CA (US)

(21) Appl. No.: 18/430,229

(22) Filed: Feb. 1, 2024

(51) Int. Cl. G01V 99/00

(52) U.S. Cl. CPC G01V 99/00

(57) ABSTRACT

A method is described for generating a map indicating areas that are favorable for microbial gas generation and accumulation by determining microbial gas source rock intervals, which may include preexisting hydrocarbon accumulations; generating an average microbial transformation ratio (MTR) map; generating an average deposition rate map which is normalized; and generating a favorability index map indicating areas that are favorable for microbial gas generation and accumulation by multiplying the MTR map and the normalized average deposition rate map. The method is executed by a computer system.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for generating a map indicating favorable locations for microbial gas generation and accumulation.

### BACKGROUND

Microbially produced methane comprises a significant portion (more than 20%) of the global natural gas resource-base. Many giant gas fields around the world are derived from microbial processes. The processes of formation and accumulation of microbial gas are quite different from thermogenic gas in sedimentary basins. Microbial methane is formed at shallower depths, where conditions are anoxic, sulfates are limited, geothermal gradients and temperatures are low, and early trap formation can be confirmed. Microbial gas generation is typically viewed as being nearly simultaneous with trap formation. With such conditions, as well as the need for an effective seal, it is challenging to evaluate the potential and risk for microbial gas using conventional technologies and workflows.

Microbial methane generation is primarily influenced by the geochemical conditions in the basin, including the nature of the source, which may be sedimentary organic matter or accumulated hydrocarbons, and the extent of microbial transformation (MTR-microbial transformation ratio). The microbial transformation ratio differs from the “conventional” transformation ratio which tracks the thermal alteration of the organic matter. Aspects of seal and entrapment mechanism are the other key factors for the formation of commercial microbial gas accumulations. These accumulations are often associated with high deposition rates. Previous approaches to assessing microbial gas potential either stressed the geothermal conditions, microbial gas kinetics scheme, or geothermal gradient-deposition rate chart.

As interest in natural gas remains high, there exists a need for a method to identify areas that are favorable for microbial methane generation and accumulation.

### SUMMARY

In accordance with some embodiments, a method for generating a map indicating areas that are favorable for microbial gas generation and accumulation is disclosed. The method may determine microbial gas source rock intervals, which may include preexisting hydrocarbon accumulations; generate an average microbial transformation ratio (MTR) map; generate an average deposition rate map which is normalized; and generate a favorability index map indicating areas that are favorable for microbial gas generation and accumulation by multiplying the MTR map and the normalized average deposition rate map. In an embodiment, the average deposition rate map is normalized such that all values are between 0-1. The MTR map may be generated using microbial gas generation kinetics. In an embodiment, the determining microbial gas source rock intervals includes determining a 80° C. temperature isothermal depth as the base of the methanogenesis zone.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for identifying areas that are favorable for microbial gas generation and accumulation;

FIG. 2 illustrates an example method for identifying areas that are favorable for microbial gas generation and accumulation;

FIG. 3 illustrates a step of an example method for identifying areas that are favorable for microbial gas generation and accumulation;

FIG. 4 illustrates a step of an example method for identifying areas that are favorable for microbial gas generation and accumulation; and

FIG. 5 illustrates steps of an example method for identifying areas that are favorable for microbial gas generation and accumulation and a resultant favorability index map.

Like reference numerals refer to corresponding parts throughout the drawings.

### DETAILED DESCRIPTION OF EMBODIMENTS

Described below are methods, systems, and computer readable storage media that provide a manner of identifying areas that are favorable for microbial gas generation and accumulation.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The present invention is an approach to integrate two factors (MTR and Deposition Rate) quantitatively in a three-dimensional (3D) framework using basin modeling software packages such as Trinity or PetroMod and others that may be available to predict favored locations for microbial gas generation and accumulation. This invention comprises a novel technology and workflow for microbial gas exploration.

A microbial gas potential index, named “Favorability Index”, defined as a product of microbial transformation ratio (MTR) and deposition rate (D-Rate), derived from a 3D basin model, is introduced to represent the favorability of microbial gas generation and entrapment in a basin and to predict microbial gas potential and favorable localities in an exploration area.

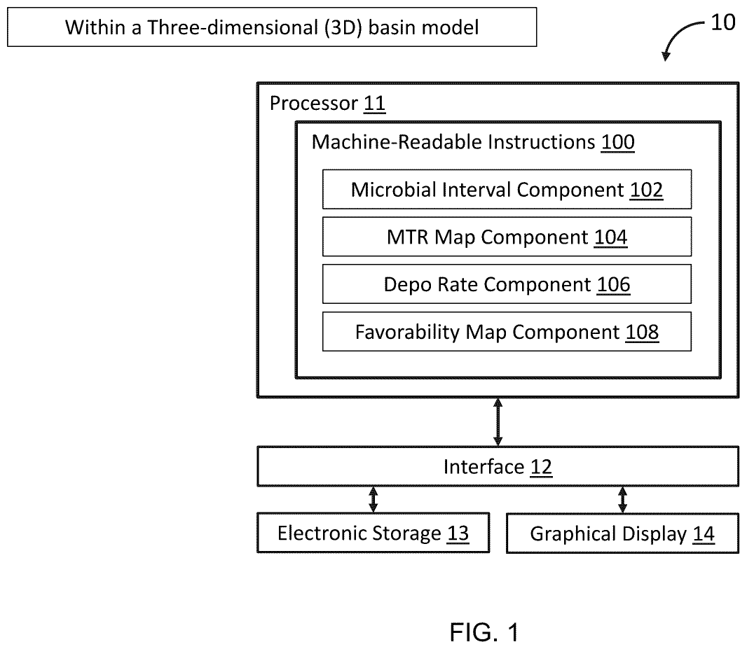

The methods and systems of the present disclosure may be implemented by a system and/or in a system, such as a system 10 shown in FIG. 1. The system 10 may include one or more of processor 11, an interface 12 (e.g., bus, wireless interface), an electronic storage 13, a graphical display 14, and/or other components.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to source rock input information, and/or other information. For example, the electronic storage 13 may store information relating to output microbial gas favorability, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to microbial transformation ratio, deposition rate, favorability index, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate identifying areas that are favorable for microbial gas generation and accumulation. The machine-readable instructions 100 may include one or more computer program components. The machine-readable instructions 100 may include a microbial interval component 102, a MTR map component 104, a depo rate component 106, a favorability map component 108, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the microbial interval component 102 may be configured to determine microbial source rock intervals.

The MTR map component 104 may be configured to generate a MTR map using microbial gas generation kinetics.

The depo rate component 106 may be configured to generate a depositional rate map by calculating an average depositional rate (D-rate) using the age of the base of source interval or pre-existing hydrocarbon accumulations to present-day and construct a D-Rate map to compute the sealing capabilities of the microbial gas traps due to deposition rate. This component is linearly scaled to a normalized D-rate map with its value varying between 0-1, calculated by:

Normalized D-rateᵢ=(D-rateᵢ−Min_D-rate)/(Max_D-Rate−Min_D-Rate);

where i denotes the ith cell of the map area, Min_D-Rate is the minimum deposition rate and Max_D-Rate is the maximum deposition rate observed in the area. The normalized D-rate sets 0.0 for the minimum deposition rate and 1.0 is assigned for the maximum deposition rate, respectively. Values for all other cells are scaled proportionately within this range. Depositional rate takes into account the necessary corrections for compaction as a result of overburden development.

The favorability map component 108 may be configured to determine a microbial gas favorability index map.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all the functionality attributed to one or more of computer program components described herein.

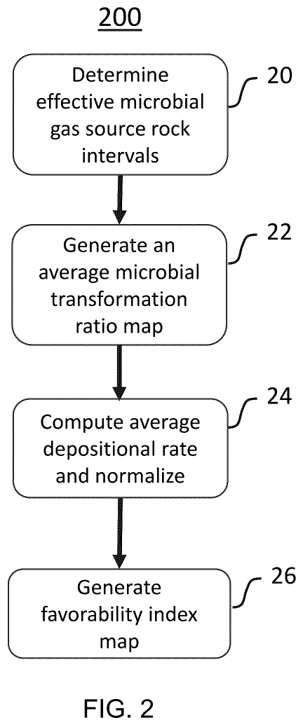

FIG. 2 illustrates an example process 200 for identifying cells within a 3D basin model that are favorable for microbial gas generation and accumulation. Steps 22 and 24 may be performed either sequentially or parallelly, depending on the design of the employed basin modeling software. A favorability map is generated through looping over all the cells in the entire study area. The required input data for the process is source rock (TOC, total organic carbon)) information, which either comes from well measurements or background TOC contents in sediments, and/or information about pre-existing hydrocarbon accumulations, such as oil fields/pools which may undergo bacterial alteration yielding microbial methane. The process also requires all the input of a basin model, including depth maps, ages of these depth maps, sediment types, and thermal gradients etc.

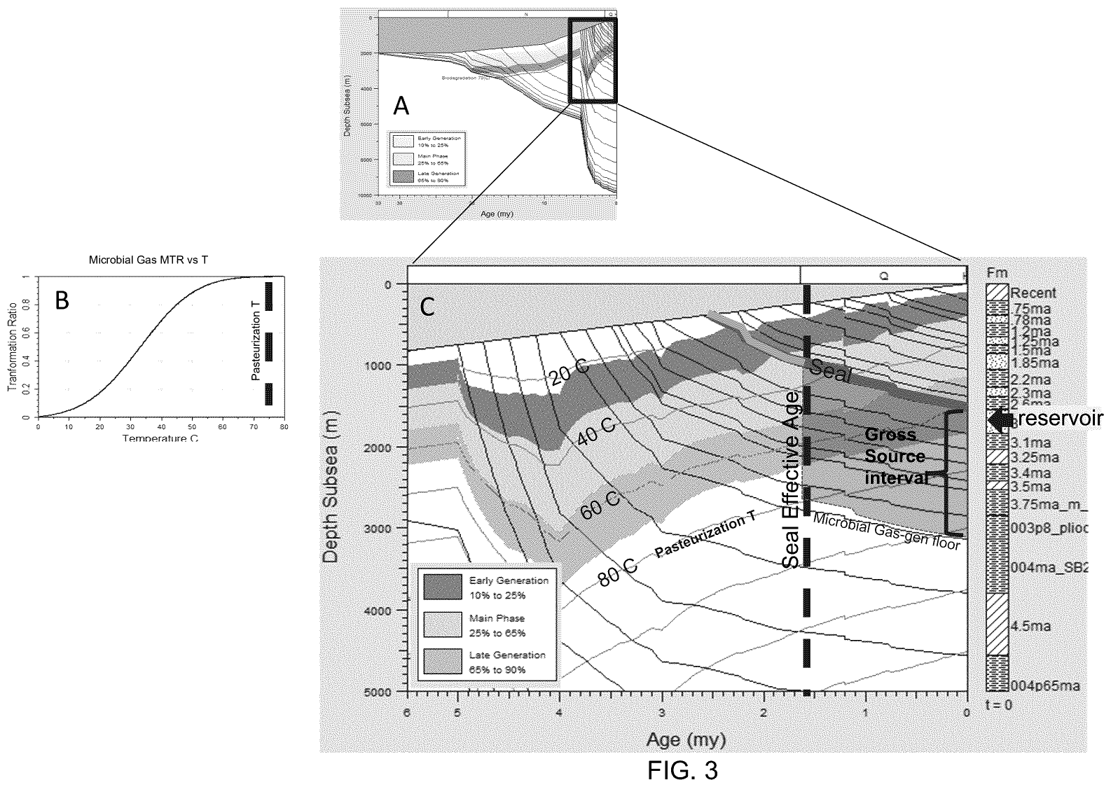

At step 20, the process determines gross microbial source rock intervals. Microbial source rocks are rock intervals generally at shallower depths (normally ranging from few hundred meters to less than three thousand meters) than those associated with thermogenic gas generation. In order to support methanogenesis, which is a strictly anaerobic process, these rocks need to exist where conditions are anoxic and sulfates are limited. Furthermore, the geothermal gradients and temperatures within this interval need to be low. Microbial gases are generated at lower temperatures and through biochemical reactions. This step uses TOC information of the gross source interval or the volume and composition of pre-existing hydrocarbon accumulations in the study area (oil fields/pools). It also defined by the paleo 80° C. temperature isothermal depth map in at the time when the seal or trap became effective as the base of the source interval and the reservoir depth map as the top of the source interval. This isothermal depth map is established using the basin modeling software and the regional structure and/or isopach maps. The 80° C. isothermal places a limit on significant methanogenic activity which is how microbes generate microbial gas. A workflow is illustrated in FIG. 3 with three steps: A) identifying effective “trap/seal” formation age; B) finding gas generating floor with that age's pasteurization temperature; and C) determining gross source interval.

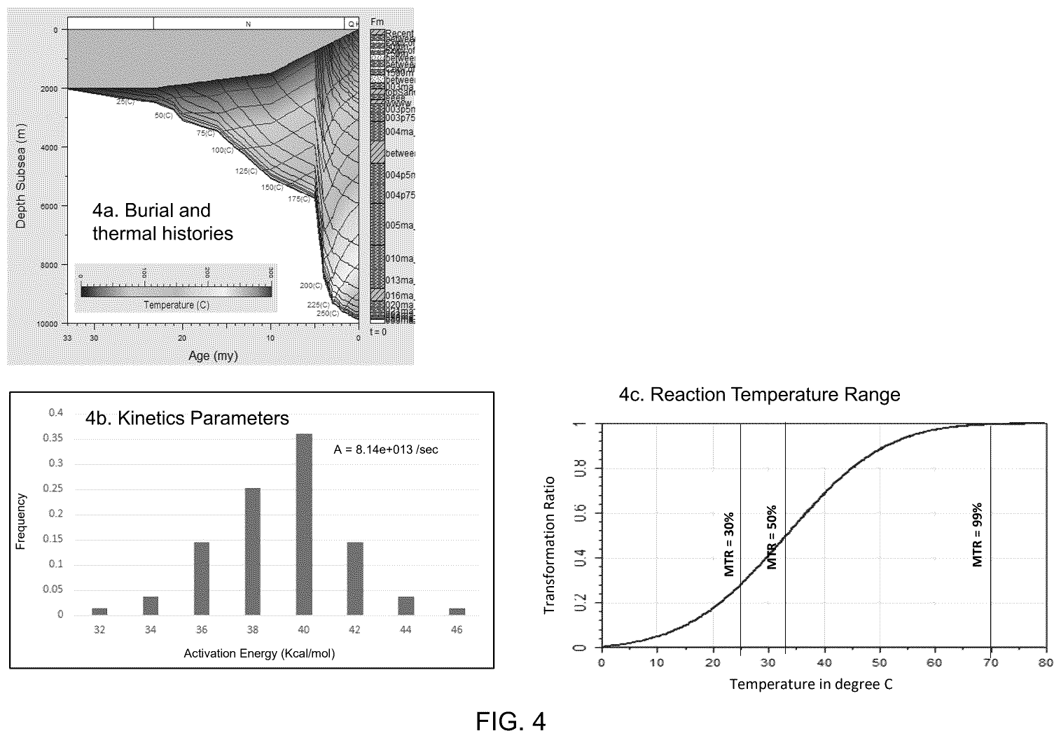

At step 22 of process 200, the process generates an average MTR map for the organic material in a 3D basin modeling software using a new scheme of microbial gas generation kinetics with the parameters such as those displayed in the FIG. 4 (4b). Kinetic models can be defined specific to the organic matter present or from the literature. The kinetic model is used to simulate microbial gas generation through time. It mimics microbial methane generation through time and changes with in-situ temperature as they impact bacterial activity during a basin's history. The bacterial activities and their relationships with microbial gas generation can be derived empirically through the inversion of field data. There are two ways to compute the MTR map: 1) divide the source interval into multiple thin layers and compute the MTR maps for each thin layer, and determine the average MTR to construct the average TR map; 2) compute MTR values at the mid-point of the source interval and generate the average MTR map. The approach used is dependent on the thickness of the proposed source and the available stratigraphic data. This is illustrated in FIG. 4, where 4a shows temperature variation in 1D (one dimension) burial history, 4b displays kinetic parameters, and 4c shows the MTR variation with temperature.

At step 24 of process 200, we compute average depositional rate (D-rate) using the age span of the base of the gross source interval or pre-existing hydrocarbon accumulations to present-day and construct a D-Rate map to compute the sealing capabilities of the microbial gas traps due to deposition rate. This component is linearly scaled to a normalized D-rate map with its value varying between 0-1, calculated by:

Normalized D-rateᵢ=(D-rateᵢ−Min_D-rate)/(Max_D-Rate−Min_D-Rate);

where i denotes the ith cell of the map area, Min_D-Rate is the minimum deposition rate and Max_D-Rate is the maximum deposition rate observed in the area. The normalized D-rate sets 0.0 for the minimum deposition rate and 1.0 is assigned for the maximum deposition rate, respectively. Values for all other cells are scaled proportionately within this range. Depositional rate takes into account the necessary corrections for compaction as a result of overburden development.

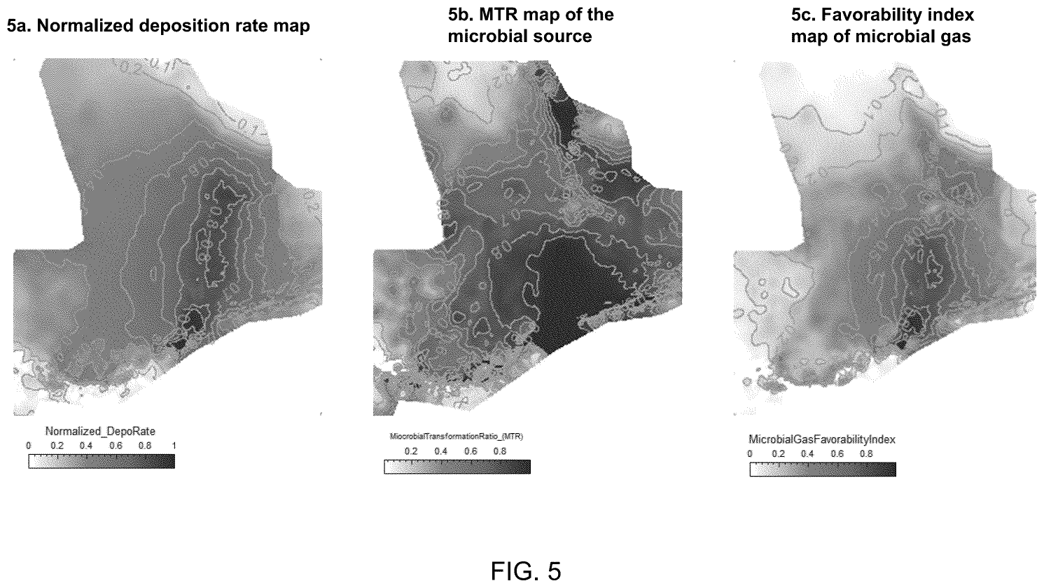

At step 26 of process 200, we multiply MTR and normalized D-Rate map to generate a Favorability Index (FI) map, with 0 as the least favorable and 1 as the most favorable locations for microbial gas generation and accumulations. Studies indicate that microbial gas accumulations are likely to occur when FI is greater than 0.5. FIG. 5 shows 5a an example of a D-rate map (before it was normalized), 5b a MTR map, and 5c the resulting favorability index map.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for generating a map indicating areas that are favorable for microbial gas generation and accumulation, comprising:
a. determining microbial gas source rock intervals;
b. generating an average microbial transformation ratio (MTR) map;
c. generating an average deposition rate map which is normalized; and
d. generating a favorability index map indicating areas that are favorable for microbial gas generation and accumulation by multiplying the MTR map and the normalized average deposition rate map.

2. The method of claim 1 wherein the microbial gas source rock intervals include preexisting hydrocarbon accumulations.

3. The method of claim 1 wherein the average deposition rate map is normalized such that all values are between 0-1.

4. The method of claim 1 wherein the MTR map is generated using microbial gas generation kinetics.

5. The method of claim 1 wherein the determining microbial gas source rock intervals includes determining a 80° C. temperature isothermal depth as base of a methanogenesis zone.

6. A computer system for generating a map indicating areas that are favorable for microbial gas generation and accumulation, comprising:
one or more processors;
memory; and
one or more programs, wherein the one or more programs are stored in the memory and configured to be executed by the one or more processors, the one or more programs including instructions that when executed by the one or more processors cause the system to:
a. determine microbial gas source rock intervals;
b. generate an average microbial transformation ratio (MTR) map;
c. generate an average deposition rate map which is normalized; and
d. generate a favorability index map indicating areas that are favorable for microbial gas generation and accumulation by multiplying the MTR map and the normalized average deposition rate map.

7. The system of claim 6 wherein the microbial gas source rock intervals include preexisting hydrocarbon accumulations.

8. The system of claim 6 wherein the average deposition rate map is normalized such that all values are between 0-1.

9. The system of claim 6 wherein the MTR map is generated using microbial gas generation kinetics.

10. The system of claim 6 wherein the determining microbial gas source rock intervals includes determining a 80° C. temperature isothermal depth as base of a methanogenesis zone.

11. A non-transitory computer readable storage medium storing one or more programs, the one or more programs comprising instructions for generating a map indicating areas that are favorable for microbial gas generation and accumulation, which when executed by an electronic device with one or more processors and memory, cause the device to
a. determine microbial gas source rock intervals;
b. generate an average microbial transformation ratio (MTR) map;
c. generate an average deposition rate map which is normalized; and
d. generate a favorability index map indicating areas that are favorable for microbial gas generation and accumulation by multiplying the MTR map and the normalized average deposition rate map.

12. The non-transitory computer readable storage medium of claim 11 wherein the microbial gas source rock intervals include preexisting hydrocarbon accumulations.

13. The non-transitory computer readable storage medium of claim 11 wherein the average deposition rate map is normalized such that all values are between 0-1.

14. The non-transitory computer readable storage medium of claim 11 wherein the MTR map is generated using microbial gas generation kinetics.

15. The non-transitory computer readable storage medium of claim 11 wherein the determining microbial gas source rock intervals includes determining a 80° C. temperature isothermal depth as base of a methanogenesis zone.
